(19) United States
(12) Patent Application Publication
(10) Pub. No.: US 2007/0284797 A1
(43) Pub. Date: Dec. 13, 2007

(54) ASSEMBLING DEVICE FOR SHEET MATERIALS

(76) Inventor: Nhon Hau Nguyen, Chester Hill N.S.U. (AU)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/675,232

(22) Filed: Feb. 15, 2007

(30) Foreign Application Priority Data
Jun. 8, 2006 (VN) 2-2006-00100

(51) Int. Cl. B25B 5/00

(52) U.S. Cl. 269/41

(57) ABSTRACT

An assembling device for sheet materials includes a supporting member including a guide rod and a supporting plate connected together to form an L-shape A clamping member includes and second clamping rods connected together at one end by a horizontal cross-member to form a substantially U-shaped. The first and second clamping rods are located on two sides of the guide rod, opposite to the outer and inner faces of the guide rod, respectively. When the first sheet is supported on the supporting plate and the second sheet is arranged to simultaneously abut against the first sheet and the inner face of the guide rod, the clamping member can be moved along the guiding groove to a suitable position and fixed at that position by a first positioning element, while a second positioning element holds the second sheet perpendicular to and abutting against the first sheet.

### TECHNICAL FIELD

The invention relates to an assembling device for easily and quickly assembling and attaching the sheets perpendicular to each other.

### SUMMARY OF THE INVENTION

It is an object of the invention to provide an assembling device for sheet materials for assembling and holding the sheets of a sheet-shaped material perpendicular to each other, thereby to attach the sheets perpendicular to each other in an easy and quick manner.

In order to achieve the above-described object of the invention, in one embodiment, there is provided an assembling device for sheet materials comprising:

a supporting member including a guide rod and a supporting plate, which are connected together to form an L-shaped configuration, and the guide rod substantially perpendicular to a supporting surface of the supporting plate, wherein:
the supporting plate is adapted to support a first sheet on the supporting surface in the direction substantially perpendicular to the guide rod,
an inner face of the guide rod, facing the supporting plate, is adapted to support a second sheet in the direction substantially perpendicular to and abutting against the first sheet; and an outer face of the guide rod, on the side opposite to the inner face, is formed with a longitudinal guiding groove;

a clamping member including

a first clamping rod and a second clamping rod connected together at one end by a horizontal cross-member to form a substantially U-shaped configuration; the U-shaped clamping member is put over the head of the guide rod so that the first and second clamping rods are located on two sides of the guide rod, opposite to the outer face and the inner face of the guide rod, respectively;
a first positioning means formed at the free end of the first clamping rod, the means includes a slider having a cross section adapted to fit in the guiding groove of the guide rod and be able to slide together with the first clamping rod in the groove and a fixing member for fixing the position of the first clamping rod with respect to the guide rod;
a second positioning means formed at the free end of the second clamping rod to firmly hold the second sheet when the sheet is placed into between the guide rod and the second clamping rod;

thereby when the first sheet is supported on the supporting plate and the second sheet is arranged in such a way as to simultaneously abut against both the first sheet and the inner face of the guide rod, the clamping member can be moved along the guiding groove to a suitable position and fixed at that position by the fixing member of the first positioning means, while the second positioning means holds the second sheet perpendicular to and abutting against the first sheet.

With the above arrangement, the assembling device for sheet materials according to the invention can assemble and hold the sheets of a sheet-shaped material perpendicular to each other, thereby facilitating the attachment of the sheets perpendicular to each other in an easy and quick manner.

In a preferred embodiment, the supporting member of the assembling device for sheet materials further comprises a holding means formed at the said supporting plate, so that when the first sheet is located on the supporting surface of the supporting plate, the first sheet is held in place by the holding means.

Preferably, the holding means of the supporting member includes a circular concave portion which is formed at the supporting surface of the supporting plate, wherein the circular concave portion is stepped to contain therein a circular concave plate made of a flexible material, and an adjusting screw which is provided on the surface opposite to the supporting surface and in the position facing the concave portion, wherein the adjusting screw has a screw end, which is fastened to the circular concave plate, and a manually rotatable knob, so that when the first sheet is located on the supporting surface of the supporting plate and the adjusting screw of the holding means is adjusted, the circular concave plate will create a vacuum space between the surface of the circular concave plate and the surface of the first sheet, thereby creating a suction force on the surface of the first sheet to hold the sheet in place.

Preferably, the circular concave plate is made of rubber.

In a preferred embodiment, the supporting plate of the supporting member is shaped into a substantially circular configuration.

In a preferred embodiment, the guiding groove of the guide rod of the supporting member has a substantially T-shaped cross section and the slider of the first positioning means of the clamping member also has a corresponding substantially T-shaped cross section.

In a preferred embodiment, the first positioning means of the clamping member is a screw with one end having a manually rotatable knob, the screw is mounted through a hole, which is formed at the free end of the first clamping rod, while the other end of the screw is screwed on the slider.

In a preferred embodiment, the second positioning means of the clamping member is a screw with one end having a manually rotatable knob, the screw is screwed through a threaded hole, which is formed at the free end of the second clamping rod, while the other end of the screw is pivotally mounted to a block, which in turn is pressed against the second sheet by the screw.

### BRIEF DESCRIPTION OF THE DRAWINGS

The above and other objects, features and advantages of the assembling device for sheet materials according to the invention can be more clearly understood on the basis of the following description of the embodiments with reference to the enclosed drawings, in which:

FIG. 1 is a perspective view of the assembling device for sheet materials according to an embodiment of the invention;

FIG. 2 is a partially cut elevation view of the assembling device for sheet materials of FIG. 1, for assembling and attaching the sheets with unbeveled edges; and

FIG. 3a and FIG. 3b are perspective views of the assembling devices for sheet materials of FIG. 1, for assembling and attaching the sheets with beveled edges.

### DETAILED DESCRIPTION OF THE PREFERRED EMBODIMENT

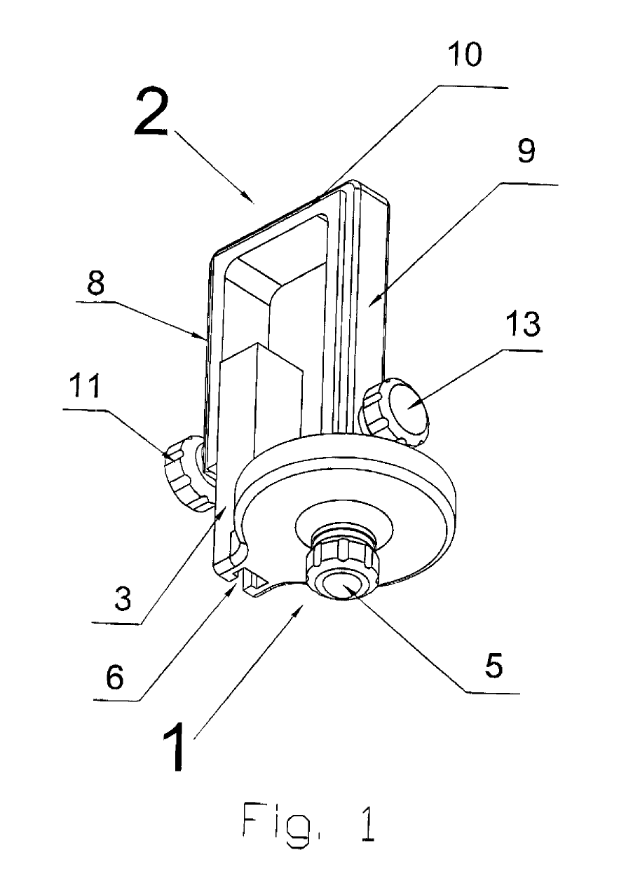

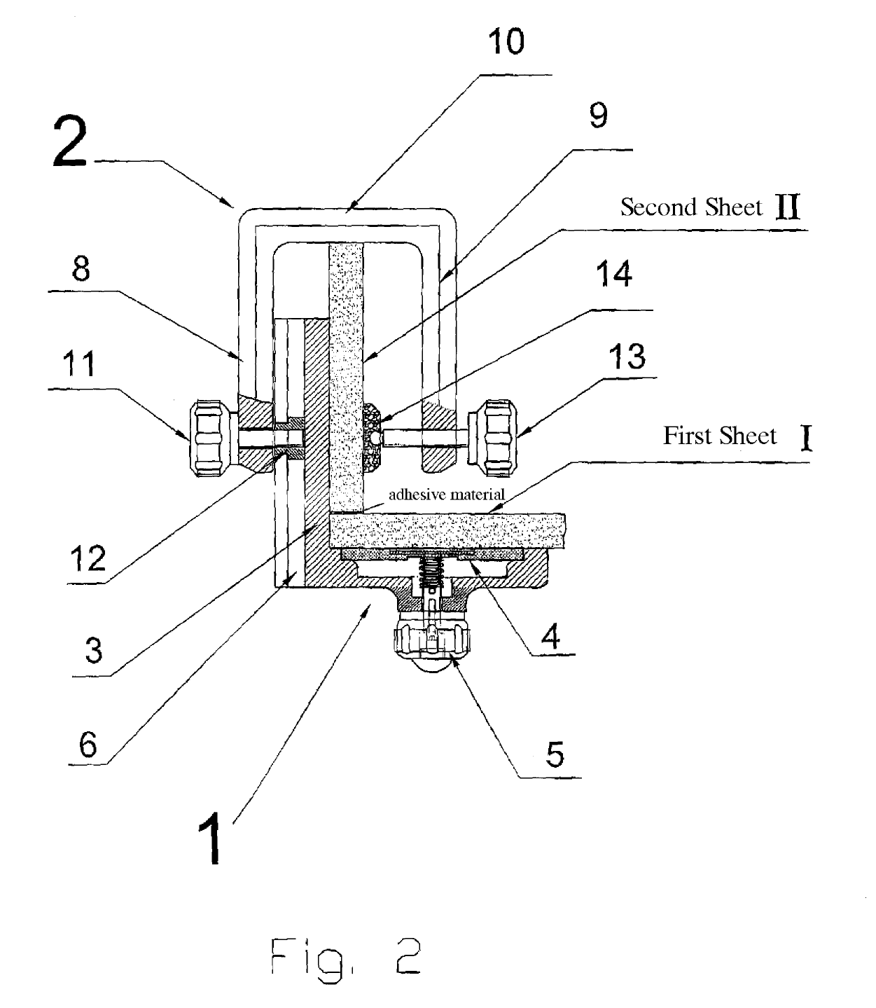

The structure of the assembling device for sheet materials according to one embodiment of the invention is shown in FIG. 1 and FIG. 2. The assembling device for sheet materials according to the invention substantially comprises a supporting member 1 and a clamping member 2.

The supporting member 1 comprises a guide rod 3 and a substantially circular shaped supporting plate 4, which are connected together to form an L-shaped configuration, as viewed in elevation plan. The supporting plate 4 has a supporting surface substantially perpendicular to the guide rod 3. The supporting surface of the supporting plate 4 is adapted to support a first sheet I in the direction substantially perpendicular to the guide rod 3. Furthermore, the supporting member 1 further comprises a holding means 5, which is provided on the supporting plate 4 of the supporting member 1, so that when the first sheet I is located on the supporting surface of the supporting plate 4, the first sheet I is held in place by the holding means 5. The guide rod 3 comprises an inner face and an outer face. The inner face of the guide rod 3 faces to the supporting plate 4 and is adapted to support a second sheet 11 in the direction substantially perpendicular to and abutting against the first sheet. The outer face of the guide rod 3 is opposite to the inner face and the guiding groove 6, having a T-shaped cross section, is formed on the outer face of the guide rod 3 along the longitudinal direction of the rod.

The clamping member 2 comprises a first clamping rod 8 and a second clamping rod 9. The clamping rods are connected together at one end thereof by a horizontal cross-member 10 to form a substantially U-shaped configuration. The U-shaped clamping member is put over the head of the guide rod 3 so that the first clamping rod 8 and the second clamping rod 9 are located on two sides of the guide rod 3, opposite to the outer face and the inner face of the guide rod 3, respectively. A first positioning means 11 is provided at the free end of the first clamping rod 8, the first positioning means 11 comprises a slider 12 having a cross section, which is adapted to fit in the guiding groove 6 of the guide rod 3 and be able to slide together with the first clamping rod 8 in the groove 6 and a fixing member for fixing the position of the first clamping rod 8 with respect to the guide rod 3. Preferably, the slider 12 also has a substantially T-shaped cross section corresponding to the T-shaped cross section of the guiding groove 6, which is formed on the outer face of the guide rod 3 along the longitudinal direction of the rod. Furthermore, a second positioning means 13 is also provided at the free end of the second clamping rod 9 to firmly hold the second sheet 11 when the sheet is placed into between the guide rod 3 and the second clamping rod.

When the first sheet I is supported on the supporting plate 4 and the second sheet 11 is arranged in such a way as to simultaneously abut against both the first sheet I and the inner face the guide rod 3, the clamping member 2 can be moved along the guiding groove 6 to the suitable position and fixed at that position by the fixing member of the first positioning means 11, while the second positioning means 13 holds the second sheet 11 perpendicular to and abutting against the first sheet 1. With the above arrangement, the assembling device for sheet materials according to the invention can assemble and hold the sheets of a sheet-shaped material perpendicular to each other so as to facilitate the attachment of the sheets perpendicular to each other in an easy and quick manner.

In a preferred embodiment, the first positioning means 11 of the clamping member 2 is a screw with one end having a manually rotatable knob. The screw is mounted through a hole, which is formed at the free end of the first clamping rod 11, while the other end of the screw is screwed on the slider 12. The second positioning means 13 of the clamping member 2 is a screw with one end having a manually rotatable knob. The screw is screwed through a threaded hole, which is formed at the free end of the second clamping rod 13, while the other end of the screw is pivotally mounted to a block 14. This block in turn is pressed against the second sheet 11 by the screw. In this embodiment, when the first sheet I is supported on the supporting plate 4 and the second sheet 11 is arranged in such a way as to simultaneously abut against both the first sheet I and the inner face of the guide rod 3, the clamping member 2 can be moved along the guiding groove 6 to the suitable position and fixed at that position by screwing the screw at the free end of the first clamping rod 11 on the slider 12. After that the screw at the free end of the second clamping rod 13 is inserted and screwed through the threaded hole, which is formed at the free end of this rod to press a block 14 against the second sheet 11. Therefore, the sheets of a sheet-shaped material can be assembled and held perpendicular to each other easily and quickly.

In another preferred embodiment, as shown in FIG. 2, the holding means 5 of the supporting member 1 comprises a circular concave portion formed at the supporting surface of the supporting plate 4. The circular concave portion is stepped to contain therein a circular concave plate made of a flexible material, which is preferably made of rubber. An adjusting screw is provided on the surface opposite to the supporting surface and in the position facing the concave portion. The adjusting screw has a screw end, which is fastened to the circular concave plate, and a manually rotatable knob, so that when the first sheet I is located on the supporting surface of the supporting plate and the adjusting screw of the holding means 5 is screwed on, the circular concave plate will create a vacuum space between the surface of the circular concave plate and the surface of the first sheet I, thereby creating a suction force on the surface of the first sheet I to hold the sheet in place.

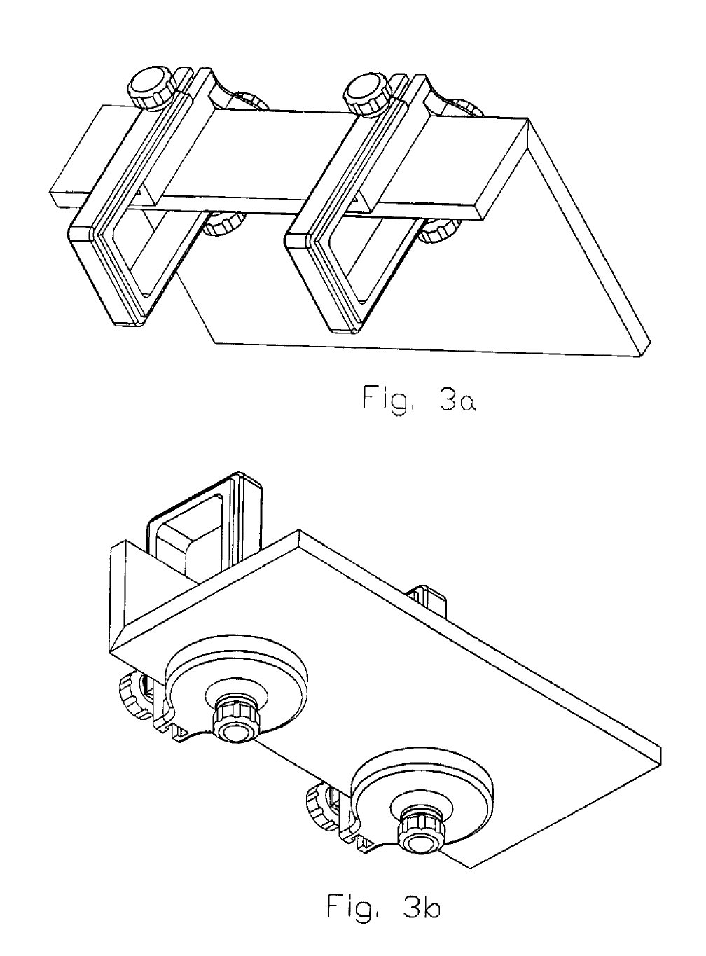

The assembling device for sheet materials according to the invention can be used for assembling and attaching the sheets with unbeveled edges, as shown in FIG. 2 or for assembling and attaching the sheets with beveled edges, as shown in FIG. 3a and FIG. 3b.

While the assembling device for sheet materials according to the invention has been described with reference to the specific embodiments of the invention, it will be appreciated by those skilled in the art that many alterations and additions can be made without departing from the scope of the invention as defined by the appended claims.

For example, the guiding groove and the slider can be created with a shape of cross section rather than the T-shaped cross section or it is possible to provide a plurality of positioning means on the second clamping rod to enhance a clamping force of the device.

1. An assembling device for sheet materials comprises:
a supporting member including a guide rod and a supporting plate, which are connected together to form an L-shaped configuration, and the guide rod substantially perpendicular to the supporting surface of the supporting plate, wherein:
the supporting plate is adapted to support a first sheet on the supporting surface in the direction substantially perpendicular to the guide rod,
an inner face of the guide rod, facing the supporting plate, is adapted to support a second sheet in the direction substantially perpendicular to and abutting against the first sheet;
and an outer face of the guide rod, on the side opposite to the inner face, is formed with a longitudinal guiding groove;
a clamping member including
a first clamping rod and a second clamping rod connected together at one end by a horizontal cross-member to form a substantially U-shaped configuration; the U-shaped clamping member is put over the head of the guide rod so that the first and second clamping rods are located on two sides of the guide rod, opposite to the outer face and the inner face of the guide rod, respectively;
a first positioning means formed at the free end of the first clamping rod, the means includes a slider having a cross section adapted to fit in the guiding groove of the guide rod and be able to slide together with the first clamping rod in the groove and a fixing member for fixing the position of the first clamping rod with respect to the guide rod;
a second positioning means formed at the free end of the second clamping rod to firmly hold the second sheet when the sheet is placed into between the guide rod and the second clamping rod;
thereby when the first sheet is supported on the supporting plate and the second sheet is arranged in such a way as to simultaneously abut against both the first sheet and the inner face of the guide rod, the clamping member can be moved along the guiding groove to a suitable position and fixed at that position by the fixing member of the first positioning means, while the second positioning means holds the second sheet perpendicular to and abutting against the first sheet.

2. The assembling device for sheet materials according to claim 1, wherein the supporting member further comprises the holding means formed at the said supporting plate, so that when the first sheet is located on the supporting surface of the supporting plate, the first sheet is held in place by the holding means.

3. The assembling device for sheet materials according to claim 2, wherein the holding means of the supporting member includes a circular concave portion formed at the supporting surface of the supporting plate, wherein the circular concave portion is stepped to contain therein a circular concave plate made of a flexible material, and an adjusting screw provided on the surface opposite to the supporting surface and in the position facing the concave portion, wherein the adjusting screw has a screw end, which is fastened to the circular concave plate, and a manually rotatable knob, so that when the first sheet is located on the supporting surface of the supporting plate and the adjusting screw of the holding means is adjusted, the circular concave plate will create a vacuum space between the surface of the circular concave plate and the surface of the first sheet, thereby creating a suction force on the surface of the first sheet to hold the sheet in place.

4. The assembling device for sheet materials according to claim 3, wherein the circular concave plate is made of rubber.

5. The assembling device for sheet materials according to claim 3, wherein the supporting plate of the supporting member is shaped into a substantially circular configuration.

6. The assembling device for sheet materials according to claim 1, wherein the guiding groove of the guide rod of the supporting member has a substantially T-shaped cross section and the slider of the first positioning means of the clamping member also has a corresponding substantially T-shaped cross section.

7. The assembling device for sheet materials according to claim 1, wherein the first positioning means of the clamping member is a screw with one end having a manually rotatable knob, the screw is mounted through a hole, which is formed at the free end of the first clamping rod, while the other end of the screw is screwed on the slider.

8. The assembling device for sheet materials according to claim 1, wherein the second positioning means of the clamping member is a screw with one end having a manually rotatable knob, the screw is screwed through a threaded hole, which is formed at the free end of the second clamping rod, while the other end of the screw is pivotally mounted to a block, which in turn is pressed against the second sheet by the screw.
